(19) United States
(12) Patent Application Publication
(10) Pub. No.: US 2015/0331557 A1
(43) Pub. Date: Nov. 19, 2015

(54) SELECTOR TO COORDINATE EXPERIENCES BETWEEN RELATED APPLICATIONS

(71) Applicant: Microsoft Corporation, Redmond, WA (US)

(72) Inventors: Nathan James Fish, Seattle, WA (US); Jason Lowell Reisman, Seattle, WA (US)

(21) Appl. No.: 14/522,539

(22) Filed: Oct. 23, 2014

Related U.S. Application Data
(60) Provisional application No. 61/996,781, filed on May 14, 2014.

(51) Int. Cl. G06F 3/0482; G06F 3/0488; G06F 3/0484

(52) U.S. Cl. CPC G06F 3/0482; G06F 3/04847; G06F 3/04842; G06F 3/04883; G06F 3/04886

(57) ABSTRACT

Systems and methods are provided to coordinate experiences between related applications in a graphical user interface. The method may include receiving handwriting input in a primary application, and extracting structured data from the received handwriting input. The method may further include displaying a selector in the primary application indicating that there are one or more launchable secondary applications that can process the structured data, the selector being initially displayed in a collapsed state as a virtual button. The method may further include receiving a user selection of the button, and then displaying the selector in an expanded state in which one or a plurality of menu options are displayed, each corresponding to one of the launchable secondary applications. The method may further include receiving a user selection of one of the plurality of launchable secondary applications, and launching the secondary application that is selected by the user.

### CROSS REFERENCE TO RELATED APPLICATIONS

This application claims priority to U.S. Provisional Patent Application Ser. No. 61/996,781, filed May 14, 2014, and titled “Claiming Data from a Virtual Whiteboard”, the entire disclosure of which is incorporated by reference for all purposes.

### BACKGROUND

Users interact with touch sensitive displays in a variety of ways. For example, many touch sensitive displays are configured to receive handwriting input via a digit or stylus of a user, for processing by an associated computer system. One application program of such a computer system that makes use of handwriting recognition is a whiteboard application. However, as discussed below, the user experience of interacting with a whiteboard application can be fragmented from other applications within an application ecosystem in an operating environment.

### SUMMARY

Systems and methods are provided to coordinate experiences between related applications in a graphical user interface (GUI). According to one aspect, the method may include displaying within a primary application a GUI with a handwriting input area, and receiving a handwriting input in the handwriting input area of the GUI. The method may further include extracting structured data from the received handwriting input, and displaying a selector within the GUI of the primary application indicating that there are one or more launchable secondary applications that can process the structured data, the selector being initially displayed in a collapsed state as a virtual button. The method may further include receiving a user selection of the button, and upon receiving the user selection of the button, displaying the selector in an expanded state, in which one or a plurality of menu options are displayed, each corresponding to one of the launchable secondary applications. The method may further include receiving a user selection of one of the plurality of launchable secondary applications, and launching the secondary application that is selected by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an interactive computing system in which a selector, displayed within a GUI of a primary application on an interactive computing system, coordinates experiences between related applications in a GUI;

FIGS. 2A-C are schematic views of a primary application executed on an interactive computing system, in which a user's input has been recognized as structured data, and a selector has been selected by a user to display a list of secondary applications.

FIG. 3 is a schematic view of a primary application and a secondary application concurrently running and being displayed in a split screen mode on a display.

FIG. 4 is a schematic view of a secondary application, in which a second selector has been selected by a user to display a list of launchable secondary applications and a primary application.

FIG. 5 is a flow diagram depicting an embodiment of a method of selecting and launching a secondary application using a selector on a GUI of a primary application.

FIGS. 6A and 6B are schematic views of a primary application executed on an interactive computing system, in each of which a user's handwriting input has been recognized as structured data, and a respective selector has been displayed in an expanded state including a list of a plurality of different secondary applications, each of which is launchable based on the detected structured data.

FIG. 7 schematically depicts a non-limiting embodiment of an interactive computing system in accordance with an embodiment of the present disclosure.

### DETAILED DESCRIPTION

Computer programs such as whiteboard applications may be designed to facilitate drawing and writing by several individuals at once, and are used with various types of computing systems, including desktop personal computers, tablet computers, and large format interactive whiteboards that can be hung in classrooms and conference rooms. Such applications enable the user to record user handwriting input, and save the handwriting input for later recall.

However, conventional whiteboard applications suffer from the following drawbacks. Should the user desire to use a portion of the handwriting input that has been inputted to a current instance of a whiteboard application in another application program, the user is required to exit the whiteboard application, launch the second application, and then manually input or cut and paste data from the whiteboard into the other application. This process can be time consuming and distracting, particularly when multiple users are using the same whiteboard application program at the same time. Further, this requires the user to have knowledge of the application programs that are available on the computing device currently being used, which may be a challenge when using an unfamiliar computing device, for example, during a visit to an unfamiliar conference room. The user may be forced to spend time hunting for an appropriate program. Further, even if a desired application program is eventually found by the user, the application program may not be appropriately configured to receive data from the whiteboard application, in which case the user's hunting efforts could turn out to be in vain. Such challenges remain drawbacks to the widespread adoption and use of whiteboard applications.

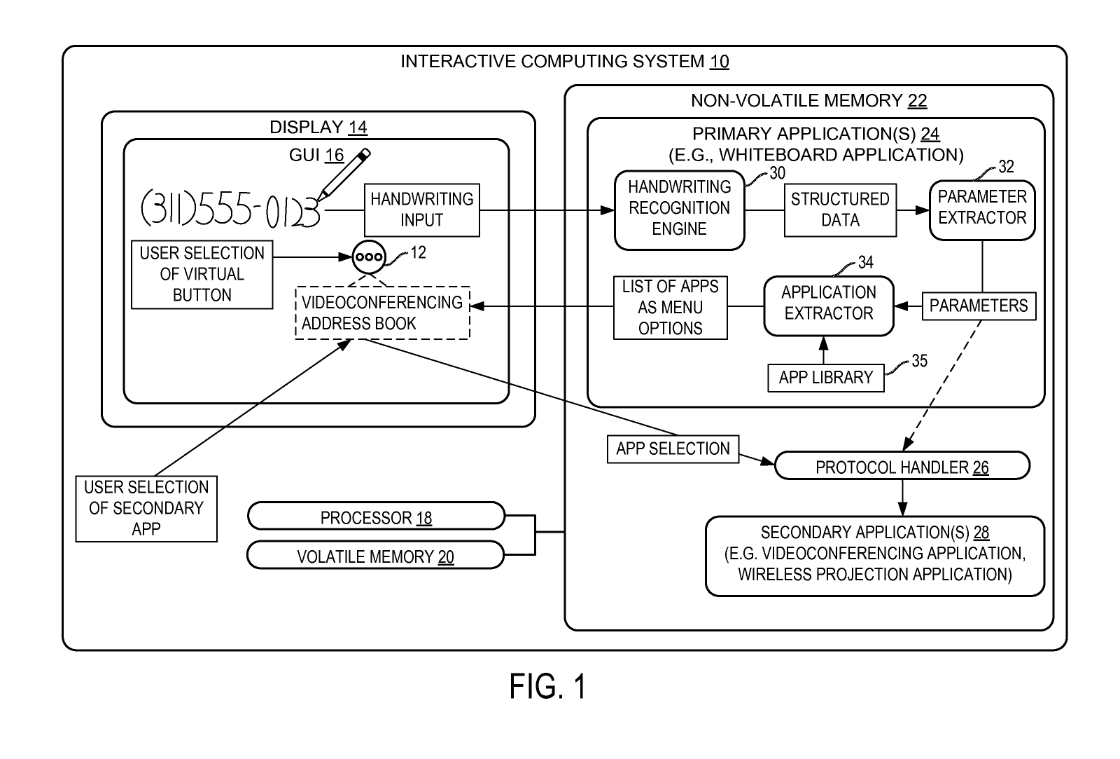

FIG. 1 shows a schematic view of an interactive computing system 10 in which a selector 12, displayed within a GUI 16 of a primary application on a display 14, coordinates experiences between related applications by enabling a user to conveniently switch back and forth between a primary application and a secondary application. The interactive computing system 10 includes a processor 18 configured to execute a primary application 24, a protocol handler 26, and a plurality of secondary applications 28 stored in non-volatile memory, using portions of volatile memory. The primary application 24 may be virtually any type of application program, and is illustrated as a whiteboard application. The secondary applications 28 also may be virtually any type of application program, and various examples are illustrated herein including a videoconferencing application, a wireless projection application, and an address book. Additional exemplary programs that may serve as the secondary application include word processing programs, spreadsheet programs, email programs, database programs, web browser programs, etc. Various input devices, such as a mouse, stylus, or touch sensing system may be provided and used to make a selection of the selector 12.

The interactive computing system 10 includes the display 14 and a processor 18 configured to execute a primary application 24 and a secondary application 28 that are stored in the non-volatile memory 22. The primary application 24 is configured to display the GUI 16 that has a handwriting input area which receives a handwriting input from the user. A handwriting recognition engine 30 is a program that recognizes the handwriting input, extracts structured data from the received handwriting input that matches the handwriting input, and sends the structured data to a parameter extractor 32. The parameter extractor 32 is a program that receives the structured data from the handwriting recognition engine 30, extracts parameters from the structured data, and sends the parameters to an application extractor 34. The application extractor 34 is a program that receives the parameters from the parameter extractor 32, extracts, or determines, compatible applications capable of launching (for example, executing) and processing the structured data from among installed applications in an application library 35, excluding the primary application 24, based on the parameters, and sends a list of the compatible applications for inclusion as menu options to the selector 12 in the GUI 16.

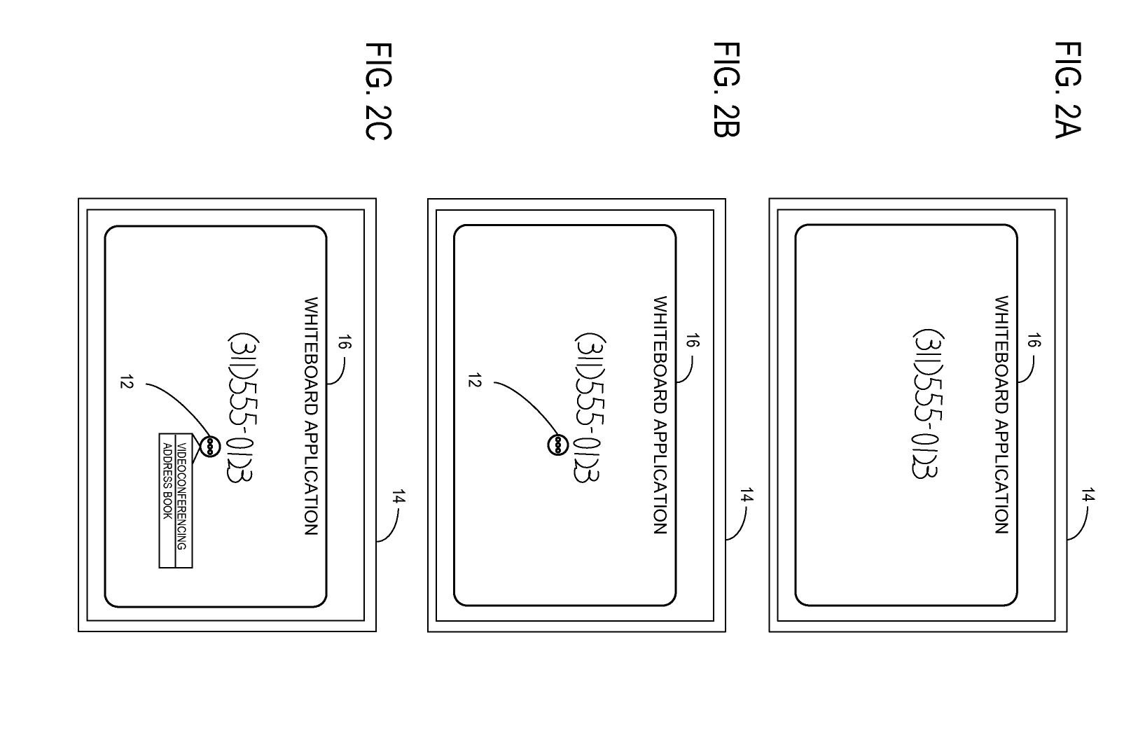

If the application extractor 34 determines that there are compatible launchable applications 28, then the primary application is configured to display the selector 12 within the GUI 16 of the primary application, indicating that there are one or more launchable secondary applications 28 that can process the structured data, the selector 12 being initially displayed in a collapsed state as a virtual button, illustrated in FIG. 2B and discussed below. Returning to FIG. 1, after display of the selector 12, the primary application is configured to receive a user selection of the virtual button. Upon receiving the user selection of the virtual button, the primary application 24 is configured to display the selector 12 in an expanded state, illustrated in FIG. 2C and discussed below, in which one or a plurality of menu options are displayed, each corresponding to one of the launchable applications. Returning to FIG. 1, after display of the selector 12 in the expanded state, the primary application is configured to receive a user selection of a menu option corresponding to a selected one of the plurality of launchable secondary applications, and the primary application is configured to launch the selected secondary application. Through the protocol handler 26, the selected secondary application may be configured to execute a predetermined action after launch. The protocol handler 26 is configured to receive parameters, which specify the predetermined action after launch, and which are extracted from the structured data, and further is configured to command the secondary application to launch and execute the predetermined action. In the above configuration, the selector is preferably displayed proximate the recognized handwriting input in the GUI of the primary application. An ellipsis is illustrated in the selector to provide a visual cue that secondary applications may be accessed by operating the selector.

FIGS. 2A-C are schematic views of the GUI 16 of a primary application in the form of a whiteboard application executed on the display 14, in which a user's input has been recognized as structured data, and the selector 12 has been selected by a user to display a list of secondary applications. Although the structured data is illustrated as a phone numbered, it will be understood that other types of structured data may be extracted, such as a person's name, place name, date, time, address, scientific or mathematical expression, etc.

In FIG. 2A, a user has inputted a phone number onto the whiteboard via finger touch or a stylus into the touch-sensitive display 14. Thus, the primary application is configured to receive this phone number as a handwriting input in the handwriting input area of the GUI, and the handwriting recognition engine is configured to extract structured data from the handwriting input. The parameter extractor extracts parameters from the structured data. For example, if the handwriting input recognizes (311) 555-0123 as structured data representing a phone number, the parameter extractor may be configured to extract the 10 digits of the phone number from the structured data, or the seven digits of the phone number after the area code. Subsequently, the application extractor extracts recommended applications, excluding the primary application capable of processing the structured data. In this example, the recommended applications include a videoconferencing application and an address book application, both of which have been determined capable of launching based on a phone number. In the example, since the structured data is a phone number, then the application extractor may not extract the wireless projection application, only extracting the videoconferencing application and the address book instead. It will be appreciated that the parameters do not include a user command for controlling a function of an application—recognizing the handwriting input in the GUI is accomplished at least in part by a handwriting recognition processing that is programmatically initiated without awaiting user input of a command or user selection of a part or a whole of the handwriting input.

Alternatively, to populate the list of menu options, the application extractor may assign each primary application its own list of launchable secondary applications. The list may be configured so that one or more launchable secondary applications are programmatically populated into a list by the primary application according to one or more predetermined rules, including sorting by frequency of use. Alternatively, one or more launchable secondary applications are configurable by the user and configured to include any applications preferred by the user. For example, if the user frequently uses the videoconferencing application and wireless projector application with the whiteboard application, the user may choose to designate the videoconferencing application and wireless projector application as secondary applications that are assigned to the primary application: the whiteboard application.

As shown on FIG. 2B, to indicate that there are one or more launchable secondary applications that can process the structured data, the primary application is configured to display the selector in a collapsed state as a virtual button. Upon receiving the user selection of the virtual button, the primary application is configured to display the selector 12 in an expanded state, as shown on FIG. 2C, in which one or a plurality of menu options are displayed, each corresponding to one of the launchable secondary applications. The user may then select and launch a secondary application from the displayed menu options in the primary application. The protocol handler may be configured to receive parameters that are extracted from the structured data, the parameters specifying a predetermined action after launch, wherein the protocol handler is further configured to command the secondary application to launch and execute the predetermined action. For example, when the primary application recognizes the handwriting as a phone number and the selector is displayed in an expanded state with a menu option for the videoconferencing application, the user may configure the latter to automatically dial the phone number and store it when it is launched. It will be appreciated that the expanded state of the selector is larger in area than the collapsed state, thus making the collapsed state more less visually obtrusive within the GUI.

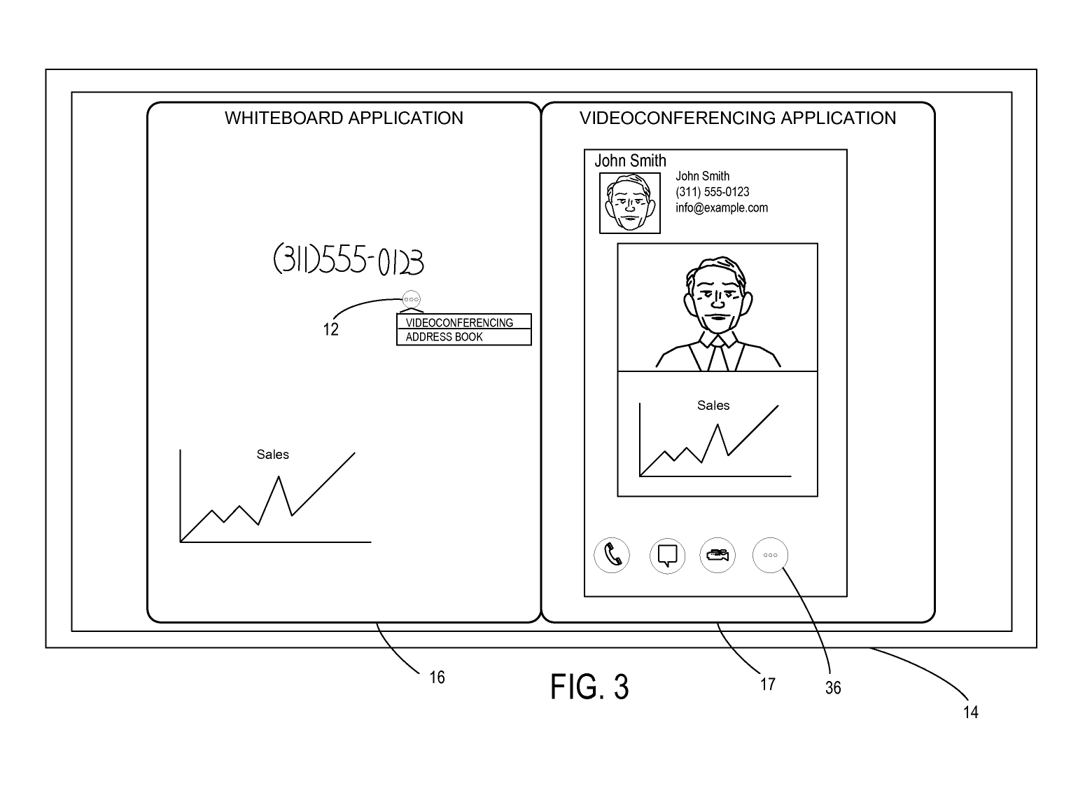

FIG. 3 shows a schematic view of a primary application (in the illustrated example a whiteboard application) and a secondary application (in the illustrated example a videoconferencing application) concurrently running and being displayed in a split screen mode on the device 14. The primary application launches the selected secondary application after the primary application receives a user selection of a menu option corresponding to a selected one of the plurality of launchable secondary applications. In this embodiment, a user has chosen the menu option corresponding to the videoconferencing application. When the user selects the secondary application, the screen is split into two halves to concurrently display the user interfaces of two applications: a primary application GUI 16 and a secondary application GUI 17, which both run concurrently. The functions of the secondary applications may be seamlessly integrated with the primary application—for example, the videoconferencing application may send handwriting input on the whiteboard to a call recipient and allow the call recipient to modify display output on the whiteboard. The position, size, and shape of each window of every application launched in parallel within the GUI may be programmatically determined or determined by user presets.

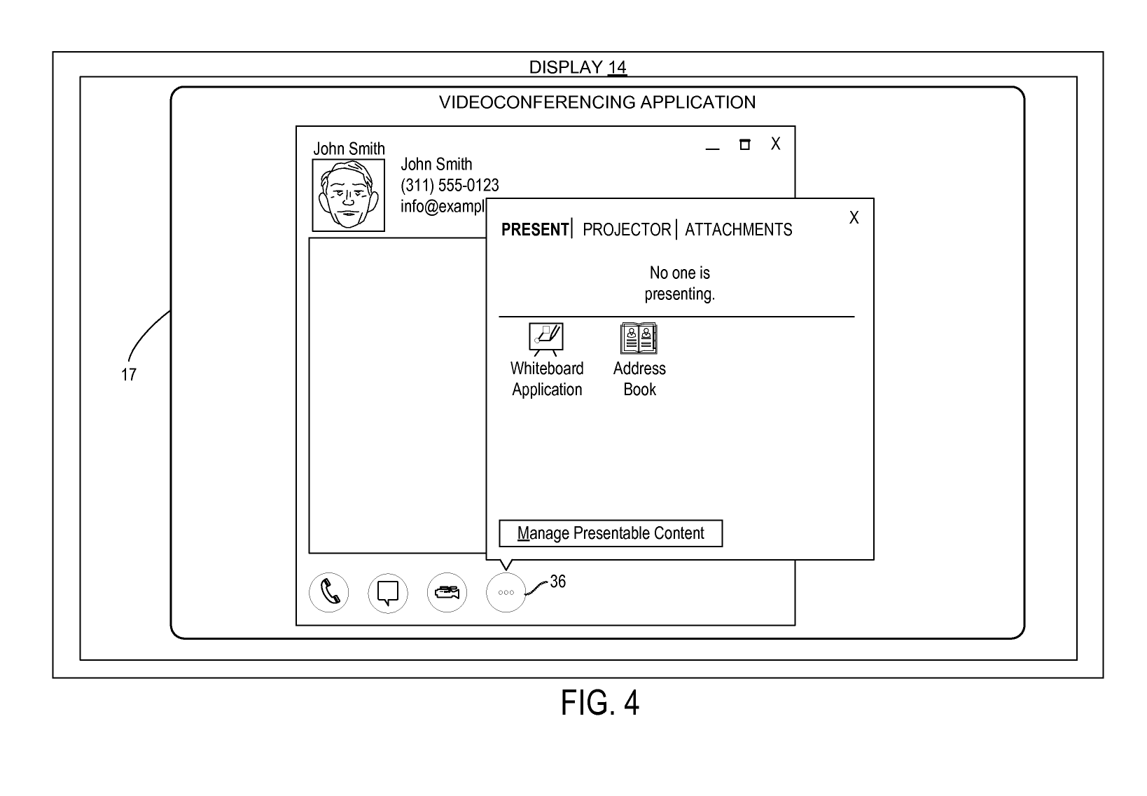

FIG. 4 shows another non-limiting embodiment of a second selector 36, which is displayed on the display 14 in the secondary application GUI 17, in this example the videoconferencing application, after the user has launched it from the primary application of FIGS. 2A-2C. In this embodiment, only the secondary application is visible on the display 14. The secondary application, the videoconferencing application, is configured to display the second selector 36 of the secondary application GUI 17, the second selector including one or more menu options, including one corresponding to the primary application (e.g., whiteboard application), and may also include one corresponding to a launchable secondary application (e.g., address book). When the secondary application receives a user selection of the one menu option corresponding to the primary application, the secondary application is configured to launch the primary application that is selected by the user, or the focus is switched to the primary application if it is running. Likewise, the user can also launch another secondary application (e.g., address book) by selecting the corresponding menu option.

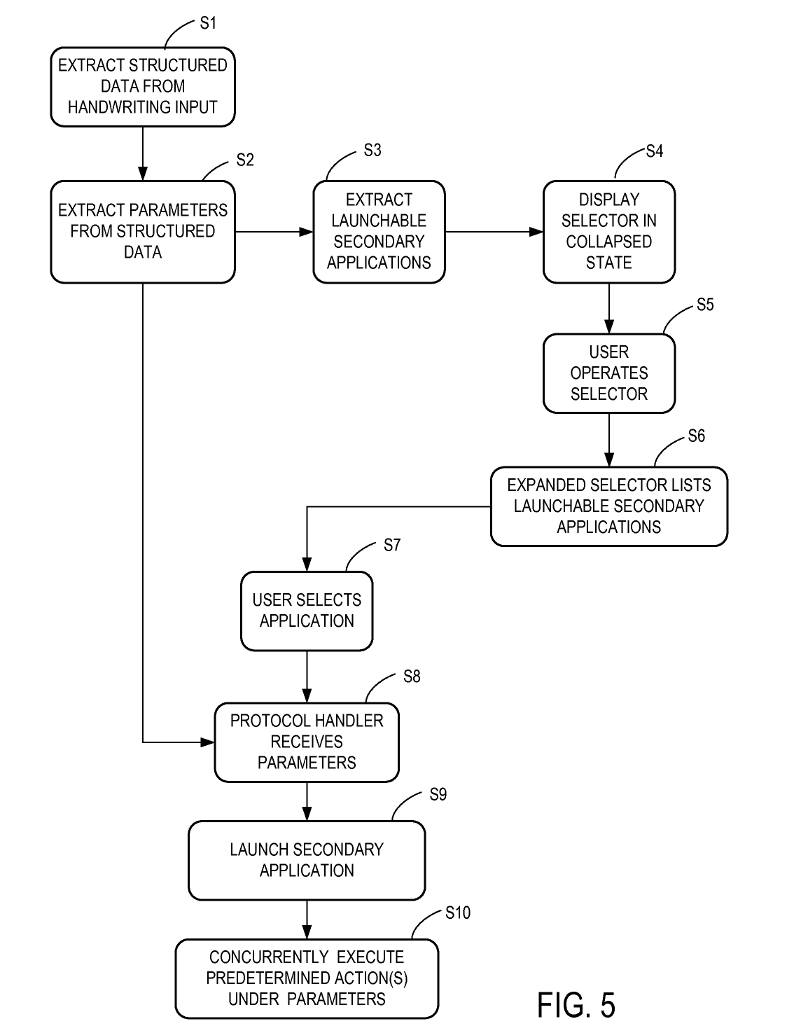

FIG. 5 shows a flow diagram depicting an embodiment of a method of selecting and launching a secondary application using the selector on the GUI of a primary application. At step S1, the handwriting recognition engine recognizes the handwriting input of the user and extracts structured data from the received handwriting input that matches the handwriting input. At step S2, the parameter extractor extracts parameters from the structured data. Then at step S3, the application extractor extracts a list of launchable secondary applications based on the parameters. At step S4, the primary application is configured to display the selector in a collapsed state as a virtual button, indicating that there are one or more launchable secondary applications that can process the structured data. At step S5, the primary application is configured to receive a user selection of the virtual button, and upon receiving the user selection of the virtual button, the selector is displayed in an expanded state, in which one or a plurality of menu options are displayed, each corresponding to one of the launchable secondary applications (step S6). Upon receiving a user selection of the menu option corresponding to the selected one of the plurality of launchable secondary applications (step S7), the primary application is configured to send parameters that specify a predetermined action from the structured data to the protocol handler (step S8) and launch the selected secondary application (step S9). The protocol handler is configured to command the secondary application to launch and execute the predetermined action (step S10). For example, when a user inputs a phone number via touch input or stylus input on a whiteboard, the whiteboard recognizes the input as a phone number and converts it into phone number parameters. The selector may appear next to the phone number or on another location on the GUI. When the user selects the selector, the videoconferencing application and the address book appear on a list. When the user selects the videoconferencing application, the protocol handler receives the phone number parameters, and upon launching, the application may dial the phone number or store it pending further instructions.

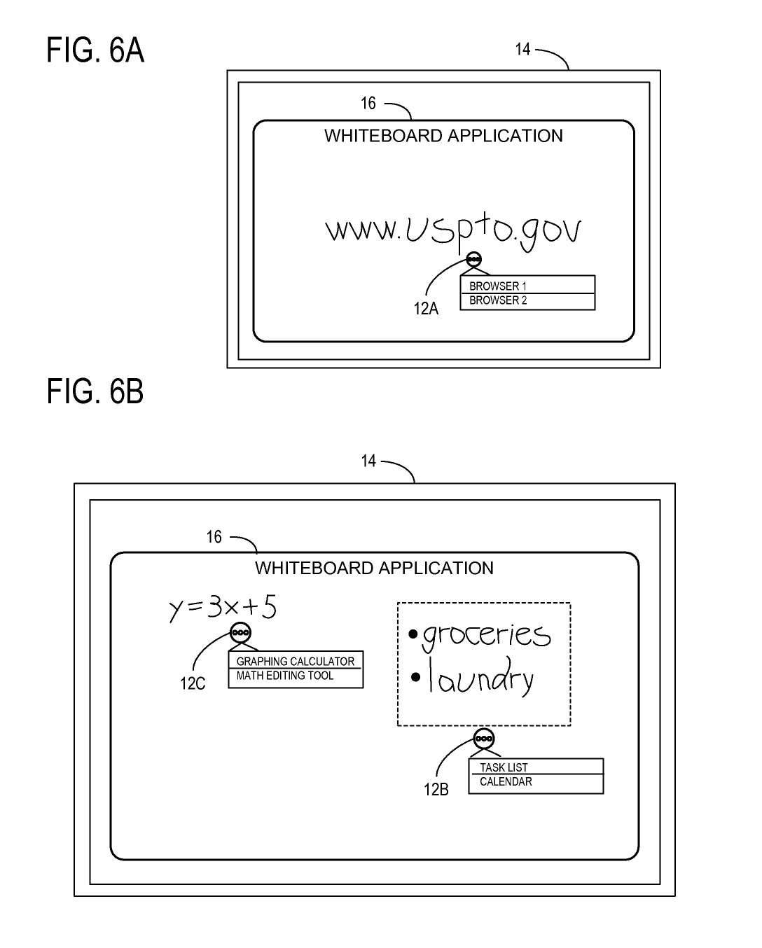

FIGS. 6A and 6B show various possible embodiments of a GUI 16 of the whiteboard application displayed on the display 14, in which various types of structured data have been extracted from a user's handwriting input, displaying multiple selectors 12A-12C with links to different secondary applications. Although the invention is described above in the context of a whiteboard as the primary application and a videoconferencing application, wireless projection application, or address book as secondary applications, it will be appreciated that other secondary applications may also be provided. For example, a video capture application could record a video of a drawing session or directly interface with a video camera to enable a live webcast. If a user scribbles a web address on the whiteboard, a web browser as a secondary application could be launched to open the web site (see FIG. 6A). If a user scribbles a mathematical equation, a graphing calculator or a mathematical editing tool as a secondary application could be launched to solve or graph the equation (see FIG. 6B). If a user starts writing a to-do list, a task list application or a calendar application as a secondary application could be launched to save it (see FIG. 6B). If a user wants to drag an existing picture onto the whiteboard, a picture gallery as a secondary application could be launched to offer a selection of image files. As shown in FIG. 6B, it will be appreciated that multiple selectors may be displayed in the same GUI if multiple sets of structured data are extracted from the user's handwriting input. A conspicuous indicator, such as a border or a highlighted region, may be provided to delineate distinct sets of structured data.

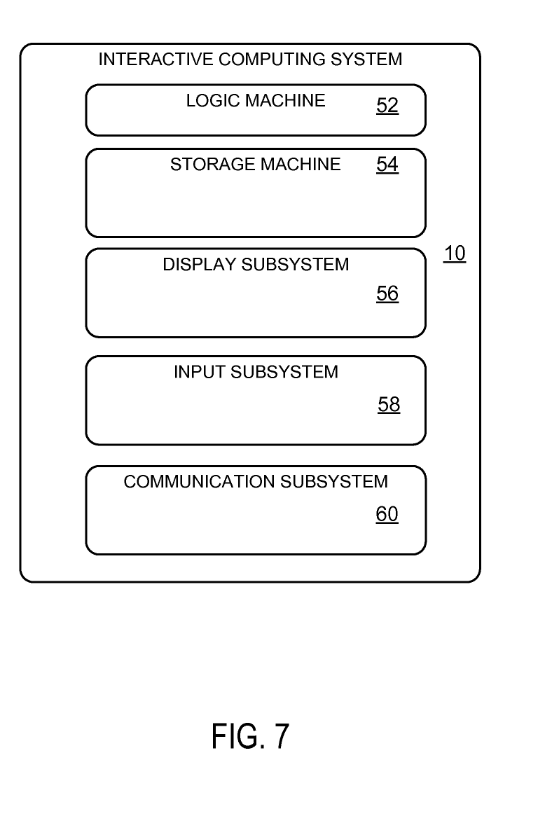

Referring to FIG. 7, the exemplary interactive computing system 10 with the display 14 is described. Interactive computing system 10 includes a logic machine 52 and a storage machine 54. Interactive computing system 10 may optionally include a display subsystem 56, input subsystem 58, communication subsystem 60, and/or other components.

Logic machine 52 includes one or more physical devices configured to execute instructions. For example, the logic machine 52 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 52 may include one or more processors configured to execute software instructions. Additionally or alternatively, the logic machine 52 may include one or more hardware or firmware logic machines configured to execute hardware or firmware instructions. Processors of the logic machine 52 may be single-core or multi-core, and the instructions executed thereon may be configured for sequential, parallel, and/or distributed processing. Individual components of the logic machine 52 optionally may be distributed among two or more separate devices, which may be remotely located and/or configured for coordinated processing. Aspects of the logic machine 52 may be virtualized and executed by remotely accessible, networked computing devices configured in a cloud-computing configuration.

Storage machine 54 includes one or more physical devices configured to hold instructions executable by the logic machine 52 to implement the methods and processes described herein. When such methods and processes are implemented, the state of storage machine 54 may be transformed—e.g., to hold different data.

Storage machine 54 may include removable and/or built-in devices. Storage machine 54 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 54 may include volatile, nonvolatile, dynamic, static, read/write, read-only, random-access, sequential-access, location-addressable, file-addressable, and/or content-addressable devices.

It will be appreciated that storage machine 54 includes one or more physical devices. However, aspects of the instructions described herein alternatively may be propagated by a communication medium (e.g., an electromagnetic signal, an optical signal, etc.) that is not held by a physical device for a finite duration.

The storage machine 54 may be configured to store the primary and secondary applications described above, as well as other software components for performing the above described methods or implementing the above described systems.

Aspects of logic machine 52 and storage machine 54 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” “application”, and “engine” may be used to describe an aspect of interactive computing system 10 implemented to perform a particular function. In some cases, a module, program, application, or engine may be instantiated via logic machine 52 executing instructions held by storage machine 54. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

Display subsystem 56 may be used to present a visual representation of data held by storage machine 54. This visual representation may take the form of a GUI. As the herein described methods and processes change the data held by the storage machine 54, and thus transform the state of the storage machine 54, the state of display subsystem 56 may likewise be transformed to visually represent changes in the underlying data. Display subsystem 56 may include one or more display devices utilizing virtually any type of technology. Such display devices may be combined with logic machine 52 and/or storage machine 54 in a shared enclosure, or such display devices may be peripheral display devices.

When included, input subsystem 58 may comprise or interface with one or more user-input devices such as a keyboard, mouse, touch screen, or game controller. In some embodiments, the input subsystem 58 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

In one example the interactive computing system 10 may be a large format interactive multi-touch sensitive display device configured to sense a contact or proximity between a digit of a user (touch input) or a stylus (stylus input) and a display surface. The interactive computing system may be configured to run an operating system, and various application programs, in a multi-threaded environment. The display device may be arranged in an array with other display devices, or by itself.

When included, communication subsystem 60 may be configured to communicatively couple interactive computing system 10 with one or more other computing devices. Communication subsystem 60 may include wired and/or wireless communication devices compatible with one or more different communication protocols. As non-limiting examples, the communication subsystem 60 may be configured for communication via a wireless telephone network, or a wired or wireless local- or wide-area network. In some embodiments, the communication subsystem 60 may allow interactive computing system 10 to send and/or receive messages to and/or from other devices via a network such as the Internet. In a one configuration, the interactive computing system may connect via a peer to peer local wireless connection, such as direct Wi-Fi, to enable other computing devices to establish connections with the interactive computing system, and send output for display on the interactive computing system 10.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

The subject matter of the present disclosure is further described in the following paragraphs. According to one aspect, the method includes displaying a graphical user interface (GUI) of a primary application, the GUI having a handwriting input area; receiving a handwriting input in the handwriting input area of the GUI; extracting structured data from the received handwriting input; displaying a selector within the GUI of the primary application indicating that there are one or more launchable secondary applications that can process the structured data, the selector being initially displayed in a collapsed state as a virtual button; receiving a user selection of the virtual button; upon receiving the user selection of the virtual button, displaying the selector in an expanded state, in which one or a plurality of menu options are displayed, each corresponding to one of the launchable secondary applications; receiving a user selection of a menu option corresponding to a selected one of the plurality of launchable secondary applications; and launching the selected secondary application; and displaying a GUI of the secondary application on the display.

In this aspect, the method may further include displaying a second selector within a GUI of the secondary application, the second selector including one or a plurality of menu options, including one menu option corresponding to the primary application; receiving a user selection of the one menu option corresponding to the primary application; and launching the primary application that is selected by the user, or switching focus to the primary application if it is running.

In this aspect, the handwriting recognition processing of the handwriting input is programmatically initiated without awaiting user input of a command or user selection of a part or a whole of the handwriting input.

In this aspect, the selected secondary application is configured to execute a predetermined action after launch.

In this aspect, the method may further include extracting parameters that specify the predetermined action from the structured data; and sending the parameters to a protocol handler, which commands the secondary application to launch and execute the predetermined action.

In this aspect, the primary application is a whiteboard application.

In this aspect, the secondary applications include a videoconferencing application and a wireless projection application.

In this aspect, the one or more launchable secondary applications are configurable by the user.

In this aspect, the one or more launchable secondary applications are programmatically populated in a list by the primary application according to one or more predetermined rules.

In this aspect, the selector is displayed proximate the recognized handwriting input in the GUI of the primary application.

According to another aspect, an interactive computing system is provided that includes a display, the interactive computing system including: a processor configured to execute a primary application and a secondary application, wherein the primary application is configured to: display a GUI of the primary application, the GUI having a handwriting input area; receive a handwriting input in the handwriting input area of the GUI; extract structured data from the received handwriting input; display a selector within the GUI of the primary application indicating that there are one or more launchable secondary applications that can process the structured data, the selector being initially displayed in a collapsed state as a virtual button; receive a user selection of the virtual button; upon receiving the user selection of the virtual button, display the selector in an expanded state, in which one or a plurality of menu options are displayed, each corresponding to one of the launchable secondary applications; receive a user selection of a menu option corresponding to a selected one of the plurality of launchable secondary applications; and launch the selected secondary application.

According to this aspect, the secondary application is configured to display a second selector of a GUI within the secondary application, the second selector including one or more menu options, including one corresponding to the primary application; receive a user selection of the one menu option corresponding to the primary application; and launch the primary application that is selected by the user, or switch focus to the primary application if it is running.

According to this aspect, recognizing the handwriting input is accomplished at least in part by handwriting recognition processing that is programmatically initiated without awaiting user input of a command or user selection of a part or a whole of the handwriting input.

According to this aspect, the selected secondary application is configured to execute a predetermined action after launch.

According to this aspect, the interactive computing system further comprises a protocol handler configured to receive parameters that are extracted from the structured data, the parameters specifying a predetermined action, wherein the protocol handler is further configured to command the secondary application to launch and execute the predetermined action.

According to this aspect, the primary application is a whiteboard application.

According to this aspect, the secondary applications include a videoconferencing application and a wireless projection application.

According to this aspect, the launchable secondary applications are programmatically populated into a list by the primary application according to one or more predetermined rules.

According to this aspect, the selector is displayed proximate the recognized handwriting input that is displayed in the GUI of the primary application.

According to another aspect, an example method is provided, which includes displaying a GUI of a primary application, the GUI having a handwriting input area; receiving a handwriting input in the handwriting input area of the GUI; extracting structured data from the received handwriting input; displaying a selector within the GUI of the primary application indicating that there are one or more launchable secondary applications that can process the structured data; receiving a user selection of the selector; upon receiving the user selection of the selector, displaying a plurality of menu options, each corresponding to one of the launchable secondary applications; receiving a user selection of a menu option corresponding to a selected one of the plurality of launchable secondary applications; launching the selected secondary application; displaying a second selector within a GUI of the secondary application, the second selector including one or a plurality of menu options, including one menu option corresponding to the primary application; receiving a user selection of the one menu option corresponding to the primary application; and launching the primary application that is selected by the user, or switching focus to the primary application if it is running.

1. A method comprising:
displaying a graphical user interface (GUI) of a primary application, the GUI having a handwriting input area;
receiving a handwriting input in the handwriting input area of the GUI;
extracting structured data from the received handwriting input;
displaying a selector within the GUI of the primary application indicating that there are one or more launchable secondary applications that can process the structured data, the selector being initially displayed in a collapsed state as a virtual button;
receiving a user selection of the virtual button;
upon receiving the user selection of the virtual button, displaying the selector in an expanded state, in which one or a plurality of menu options are displayed, each corresponding to one of the launchable secondary applications;
receiving a user selection of a menu option corresponding to a selected one of the plurality of launchable secondary applications; and
launching the selected secondary application; and
displaying a GUI of the secondary application on the display.

2. The method of claim 1, further comprising displaying a second selector within the GUI of the secondary application, the second selector including one or a plurality of menu options, including one menu option corresponding to the primary application;
receiving a user selection of the one menu option corresponding to the primary application; and
launching the primary application that is selected by the user, or switching focus to the primary application if the primary application is running.

3. The method of claim 1, wherein handwriting recognition processing of the handwriting input is programmatically initiated without awaiting user input of a command or user selection of a part or a whole of the handwriting input.

4. The method of claim 1, wherein the selected secondary application is configured to execute a predetermined action after launch.

5. The method of claim 4, further comprising:
extracting parameters that specify the predetermined action from the structured data; and
sending the parameters to a protocol handler, which commands the secondary application to launch and execute the predetermined action.

6. The method of claim 1, wherein the primary application is a whiteboard application.

7. The method of claim 1, wherein the secondary applications include a videoconferencing application and a wireless projection application.

8. The method of claim 1, wherein the one or more launchable secondary applications are configurable by the user.

9. The method of claim 1, wherein the one or more launchable secondary applications are programmatically populated in a list by the primary application according to one or more predetermined rules.

10. The method of claim 1, wherein the selector is displayed proximate the recognized handwriting input in the GUI of the primary application.

11. An interactive computing system comprising:
a touch-sensitive display configured to detect a handwriting input of a stylus or digit of a user and display output of the interactive computing system;
a processor configured to execute a primary application and a secondary application, wherein the primary application is configured to:
display a GUI of the primary application on the display, the GUI having a handwriting input area;
receive the handwriting input via the display in the handwriting input area of the GUI;
extract structured data from the received handwriting input;
display a selector within the GUI of the primary application indicating that there are one or more launchable secondary applications that can process the structured data, the selector being initially displayed in a collapsed state as a virtual button;
receive a user selection of the virtual button;
upon receiving the user selection of the virtual button, display the selector in an expanded state, in which one or a plurality of menu options are displayed, each corresponding to one of the launchable secondary applications;
receive a user selection of a menu option corresponding to a selected one of the plurality of launchable secondary applications;
launch the selected secondary application; and
display a GUI of the secondary application on the display.

12. The interactive computing system of claim 11, wherein the secondary application is configured to:
display a second selector within the GUI of the secondary application, the second selector including one or a plurality of menu options, including one menu option corresponding to the primary application;
receive a user selection of the one menu option corresponding to the primary application; and
launch the primary application that is selected by the user, or switch focus to the primary application if the primary application is running.

13. The interactive computing system of claim 11, wherein recognizing the handwriting input is accomplished at least in part by handwriting recognition processing that is programmatically initiated without awaiting user input of a command or user selection of a part or a whole of the handwriting input.

14. The interactive computing system of claim 11, wherein the selected secondary application is configured to execute a predetermined action after launch.

15. The interactive computing system of claim 14, further comprising a protocol handler configured to receive parameters that are extracted from the structured data, the parameters specifying the predetermined action after launch, wherein the protocol handler is further configured to command the secondary application to launch and execute the predetermined action.

16. The interactive computing system of claim 11, wherein the primary application is a whiteboard application.

17. The interactive computing system of claim 11, wherein the secondary applications include a videoconferencing application and a wireless projection application.

18. The interactive computing system of claim 11, wherein the one or more launchable secondary applications are programmatically populated into a list by the primary application according to one or more predetermined rules.

19. The interactive computing system of claim 11, wherein the selector is displayed proximate the recognized handwriting input that is displayed in the GUI of the primary application.

20. A method comprising:
displaying a GUI of a primary application, the GUI having a handwriting input area;
receiving a handwriting input in the handwriting input area of the GUI;
extracting structured data from the received handwriting input;
displaying a selector within the GUI of the primary application indicating that there are one or more launchable secondary applications that can process the structured data;
receiving a user selection of the selector;
upon receiving the user selection of the selector, displaying a plurality of menu options, each corresponding to one of the launchable secondary applications;
receiving a user selection of a menu option corresponding to a selected one of the plurality of launchable secondary applications;
launching the selected secondary application;
displaying a second selector within a GUI of the secondary application, the second selector including one or a plurality of menu options, including one menu option corresponding to the primary application;
receiving a user selection of the one menu option corresponding to the primary application; and
launching the primary application that is selected by the user, or switching focus to the primary application if the primary application is running.
